(19) United States
(12) Patent Application Publication
(10) Pub. No.: US 2008/0138183 A1
(43) Pub. Date: Jun. 12, 2008

(54) Lift structure

(76) Inventor: Yungh-Siang Lin, Shueishang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,182

(22) Filed: Dec. 6, 2006

(51) Int. Cl. B60P 1/02

(52) U.S. Cl. 414/546

(57) ABSTRACT

A lift includes a connecting rod secured to a vehicle, an upright guide rod connected to the connecting rod, a lifting rod, a power source, and a platform; the guide rod has a lowermost sloping side; the lifting rod includes a holding part pivoted to the guide rod, and a moving part held in the holding part; the power source is provided for moving the moving part up and down; the platform is pivoted to the moving part, and has a cylinder fitted thereon to be in touch with the guide rod; the platform will automatically pivot to a horizontal position when it is upright and lowered to such a height that the cylinder is off the guide rod; the platform will start pivoting to a vertical position when it is horizontal and lifted to such a height that the cylinder moves onto the lowermost sloping side of the guide rod.

### BACKGROUND OF THE INVENTION

1. Field of the invention

The present invention relates to an improvement on a lift, more particularly one, which is equipped with single power source to serve to lift a bearing platform and cause pivotal motion of the bearing platform between a horizontal in-use position and a vertical not-in-use one.

2. Brief Description of the Prior Art

Walk-substituting carts are usually used by the handicapped and the elderly. When the users need to go to a destination such as a resort and hospital, such carts should be transported by minibuses together with the users so that they will be available at the destination. A minibus has to be first equipped with a lift in order to transport a walk-substituting cart.

Referring to FIG. 6, a lift 8 is joined to a vehicle for allowing the vehicle to transport a walk-substituting cart. The lift 8 includes a platform 81, an up and down moving rod 82, a first power source 83, a transmission rod 84, and a second power source 85. The platform 81 includes a fixed part 811, and a moving part 812 pivoted to the fixed part 811. The fixed part 811 of the platform 81 is securely joined to the up and down moving rod 82. The first power source 83 is connected to the up and down moving rod 82 for lifting the up and down moving rod 82 and the platform 81. The transmission rod 84 is pivoted to the moving part 812 of the platform 81 at one end, and connected to the second power source 85 at the other end. A walk-substituting cart can be moved onto the platform 81 after the platform 81 is lowered to the ground by means of the first power source 83, and the moving part 812 is pivoted on the fixed part 811 to a substantially horizontal position by means of both the transmission rod 84 and the second power source 85. The walk-substituting car can be transported by the vehicle after it is lifted off the ground together with the platform 81 by means of the first power source 83.

The above lift structure has a disadvantage: the lift is equipped with the first and the second power sources, which are used to lift and to open the platform respectively, therefore it is relatively expensive to manufacture, and will consume more electrical energy.

### SUMMARY OF THE INVENTION

It is a main object of the present invention to provide an improvement on a lift to overcome the above-mentioned problems. The lift of the present invention includes a connecting rod secured to a vehicle, an upright guide rod connected to the connecting rod, a lifting rod, a power source, and a platform; the guide rod has a lowermost sloping side. The lifting rod includes a holding part pivoted to the guide rod, and a moving part held in and linearly displaceable relative to the holding part. The power source is provided to cause upward/downward motion of the moving part. The platform is pivoted to a bottom of the moving part, and has a guide cylinder fitted thereon to be in touch with the guide rod. The platform will automatically pivot to a horizontal in-use position owing to gravity when it is upright and lowered to such a position that the guide cylinder is off the guide rod. The platform will start pivoting to a vertical not-in-use position when it is horizontal and lifted to such a position that the guide cylinder comes into contact with the lowermost sloping side of the guide rod.

### BRIEF DESCRIPTION OF THE DRAWINGS

The present invention will be better understood by referring to the accompanying drawings, wherein:

FIG. 1 is an exploded perspective view of the present invention,

FIG. 2 is a front view of the present invention,

FIG. 3 is a front view of the present invention in use (1),

FIG. 4 is a front view of the present invention in use (2),

FIG. 5 is a front view of the present invention in use (3), and

FIG. 6 is a perspective view of the prior art.

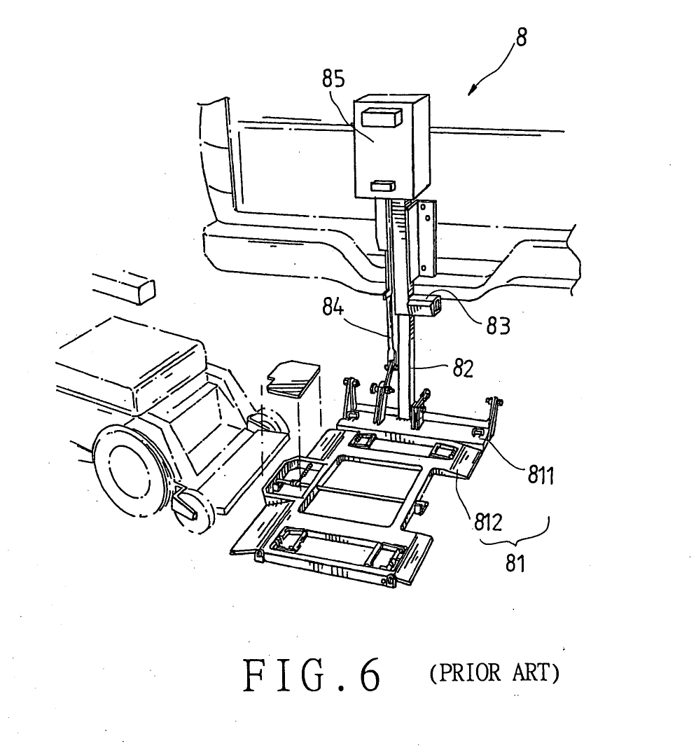

### DETAILED DESCRIPTION OF THE PREFERRED EMBODIMENTS

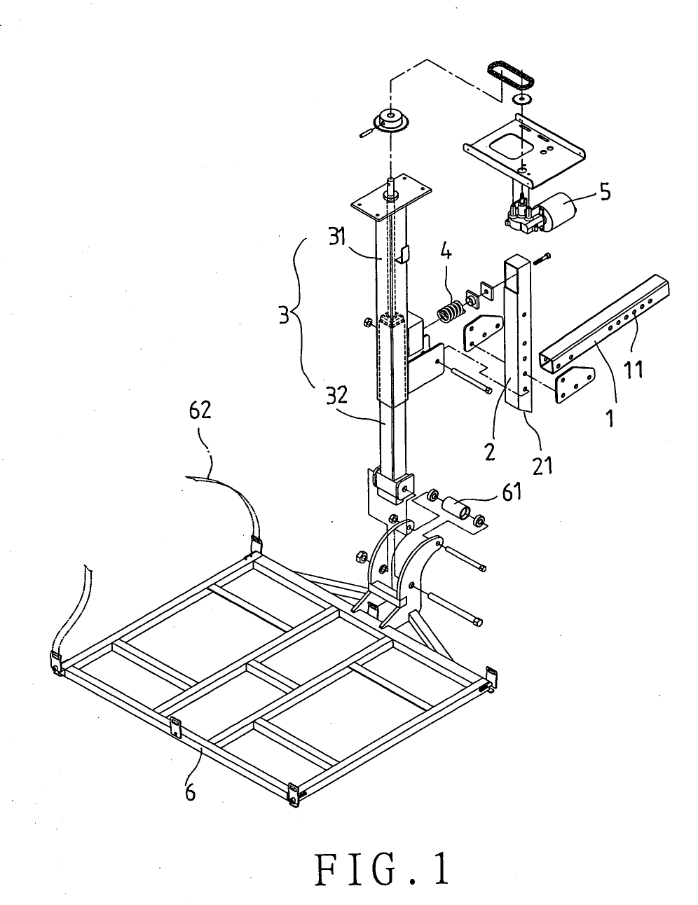

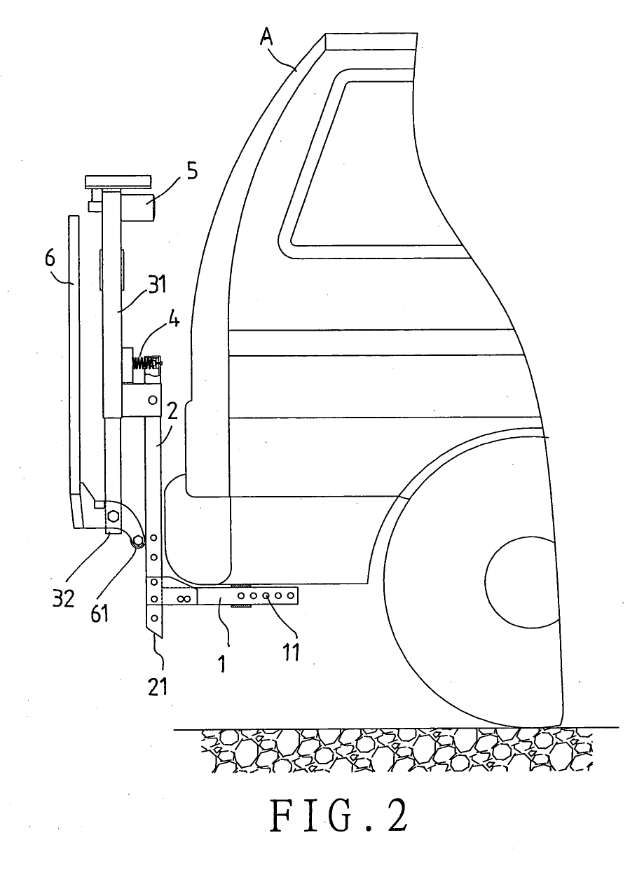

Referring to FIGS. 1 and 2, a preferred embodiment of a lift of the present invention includes a connecting rod 1, a guide rod 2, a lifting rod 3, an elastic element 4, a power source 5, and a platform 6.

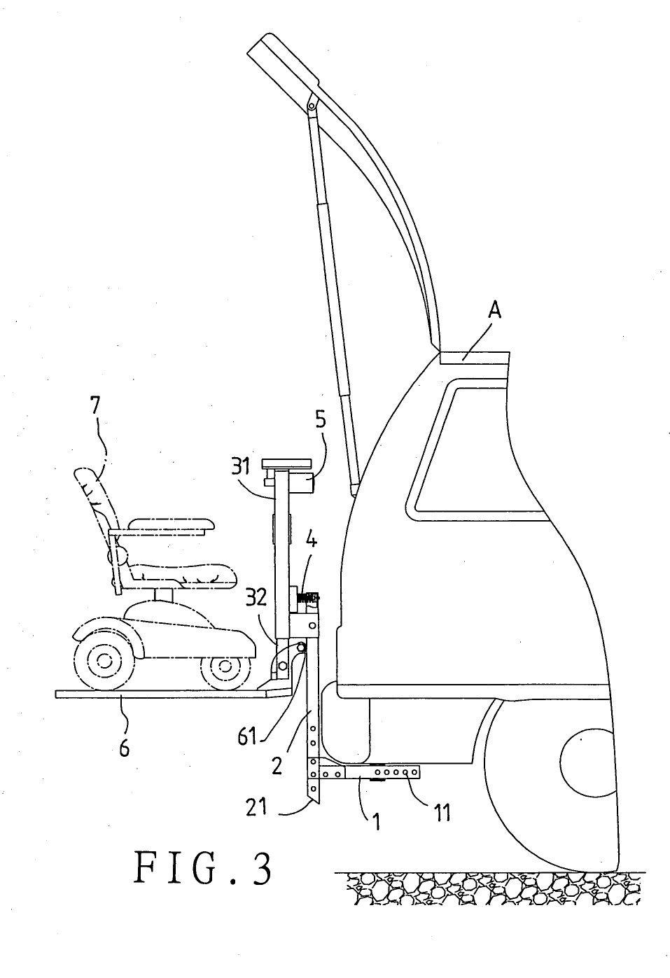

The connecting rod 1 has several receiving holes 11 thereon, and is securely joined to a vehicle (A) at a chosen one of the receiving holes 11 so that the connecting rod 1 sticks out from the vehicle (A) a desired length. The guide rod 2 is connected to the connecting rod 1, in a substantially upright position. The lifting rod 3 includes a holding part 31, and an up and down moving part 32 held in and linearly displaceable relative to the holding part 31. The guide rod 2 and the holding part 31 are pivoted together. The elastic element 4 is disposed between an upper end of the guide rod 2 and the holding part 31 of the lifting rod 3. The guide rod 2 has a lowermost sloping side 21. The power source 5 can be a motor, and is joined to the lifting rod 3 for causing upward/downward motion of the up and down moving part 32 of the lifting rod 3. The platform 6 is pivoted to a lower end of the up and down moving part 32 of the lifting rod 3. The platform 6 has a guide cylinder 61 fitted thereon to be in touch with the guide rod 2. The platform 6 has several fastening units 62 connected thereto, which are provided for fastening a walk-substituting cart supported on the platform 6 (FIG. 3).

In use, referring to FIG. 3, first the platform 6, currently in a substantially vertical position, is lowered to the ground together with the up and down moving part 32 by means of the power source 5; the guide cylinder 61 of the platform 6 will be propped by and moved relative to the guide rod 2 so as to allow the platform 6 to move down smoothly; the platform 6 will automatically pivot to a substantially horizontal position owing to gravity as soon as the up and down moving part 32 is lowered to such a position that the guide cylinder 61 is apart from the guide rod 2. Next, a walk-substituting cart 7 is moved onto the platform 6, and the fastening units 62 are used to fasten the walk-substituting cart 7 to the platform 6 finally, the power source 5 is actuated to lift the up and down moving part 32 and the platform 6 so that the walk-substituting cart 7 is lifted off the ground to a suitable height. Therefore, the walk-substituting cart 7 can be transported by the vehicle (A).

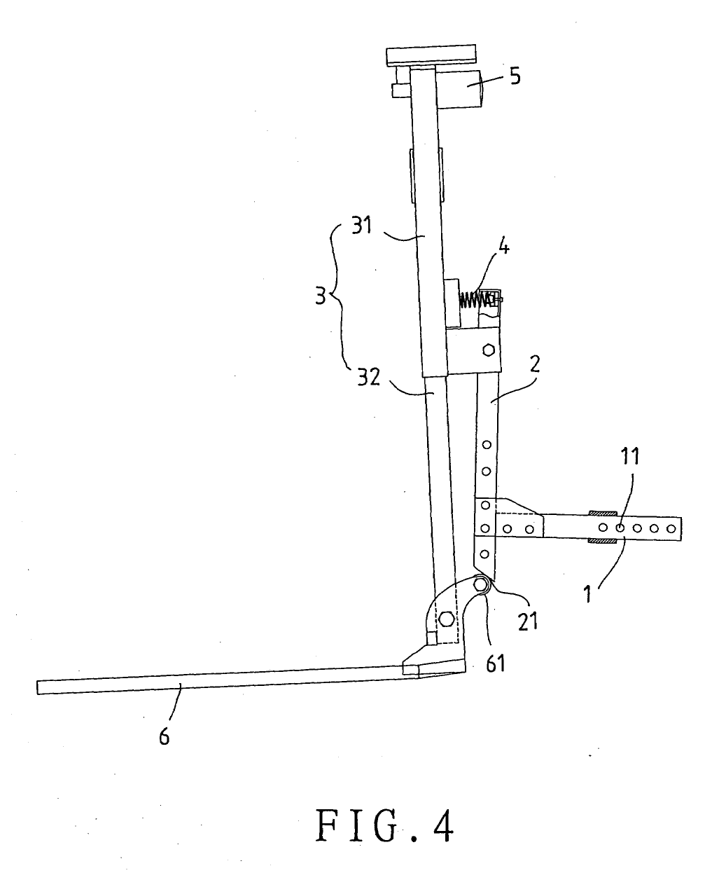

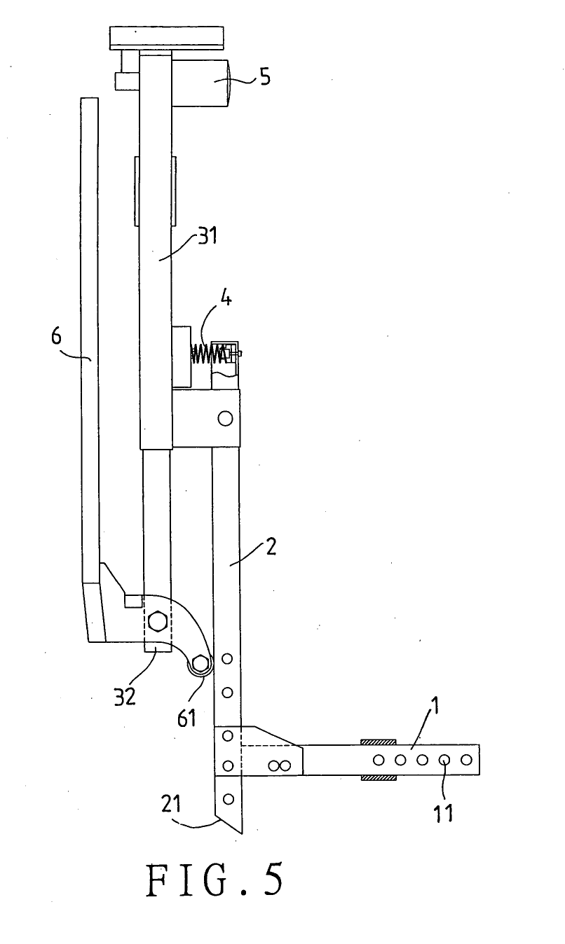

When not in use, referring to FIGS. 4 and 5, the power source 5 is actuated to lift the up and down moving part 32 so that the platform 6 is lifted and changed to a substantially vertical position with the guide cylinder 61 being pressed against an inner side of the guide rod 2, as shown in FIG. 5; the platform 6 will start to pivot from the horizontal position towards the vertical one as soon as the guide cylinder 61 comes into contact with the lowermost sloping side 21 of the guide rod 2 during the lifting motion. Consequently, the platform 6 is in a vertical and uppermost (not-in-use) position as shown in FIG. 5. Furthermore, owing to existence of the elastic element 4, the guide rod 2 will change position slightly when the guide cylinder 61 slides from the lowermost sloping side 21 of the guide rod 2 onto the inner side of the guide rod 2. Consequently, the guide cylinder 61 will move from the lowermost sloping side 21 of the guide rod 2 onto the inner side of the guide rod 2 more smoothly.

From the above description, it can be seen that the present invention has the following advantages:

1. The lift of the present invention is relatively inexpensive to manufacture because it is equipped with single power source, which can serve to lift the platform as well as causing pivotal motion of the platform between the horizontal in-use position and the vertical not-in-use one.

2. The lift of the present invention will consume less energy in use because it is equipped with single power source, which can serve to lift the platform as well as causing the platform to pivot between the horizontal in-use position and the vertical not-in-use one.

What is claimed is:

1. An improvement on a lift structure, comprising
a connecting rod securely joined to a vehicle,
a guide rod, the guide rod being connected to the connecting rod in a substantially upright position; the guide rod having a lowermost sloping side;
a lifting rod, the lifting rod including a holding part, and an up and down moving part held in and linearly displaceable relative to the holding part; the guide rod and the holding part being pivoted together;
a power source joined to the lifting rod for causing upward and downward motion of the up and down moving part of the lifting rod; and
a platform pivoted to a lower end of the up and down moving part of the lifting rod; the platform having a guide cylinder fitted thereon to be in touch with the guide rod.

2. The improvement on a lift structure as recited in claim 1 further having an elastic element interposed between an upper end of the guide rod and the holding part of the lifting rod.

3. The improvement on a lift structure as recited in claim 1, wherein the platform has a plurality of fastening units joined thereto; the fastening units being provided for fastening a walk-substituting cart supported on the platform.

4. The improvement on a lift structure as recited in claim 1, wherein the power source is a motor.

5. The improvement on a lift structure as recited in claim 1, wherein the connecting rod has a plurality of receiving holes thereon.
